(19) United States
(12) Patent Application Publication
(10) Pub. No.: US 2006/0197717 A1
(43) Pub. Date: Sep. 7, 2006

(54) Method for transmitting data from slave terminals to a master terminal via a communication bus

(75) Inventor: Tan Duc Huyn, Neuilly Sur Marne (FR)

Correspondence Address: Valeo Climate Control Corp.;Intellectual Property Dept., 4100 North Atlantic Boulevard, Auburn Hills, MI, 48326, US

(73) Assignee: Valeo Systemes Thermiques S.A.S., Le Mesnil St. Denis (FR)

(21) Appl. No.: 11/365,301

(22) Filed: Mar. 1, 2006

(30) Foreign Application Priority Data
Mar. 1, 2005 (FR) 05 02058

(51) Int. Cl. G09G 1/08

(52) U.S. Cl. 345/13

(57) ABSTRACT

Method for transmitting data from a plurality of slave terminals (TE1, TE2, TE3, TE4) to a master terminal (TM) via a communication bus (10). According to the invention, said method includes the following steps:
(a) the master terminal (TM) transmits a check sequence (SCi) including a response sequence (SRi), intended to receive, from the slave terminals (TE1, TE2, TE3, TE4), an indicator of the presence of data to be transmitted, (b) the slave terminals provide said presence indicator in said response sequence (SRi), (c) the master terminal (TM) provides a data transmission authorization (SA) to a slave terminal of which the indicator of the presence of data to be transmitted is positive, (d) said slave terminal transmits said data after receiving the authorization from the master terminal, (e) steps (c) and (d) are repeated for any slave terminal of which the indicator of the presence of data to be transmitted is positive. Application to motor vehicle air conditioning systems.

This invention relates to a method for transmitting data from a plurality of slave terminals to a master terminal via a communication bus.

The invention has a particularly advantageous application in any installation where slave terminals must transmit, along a communication bus, data to a master terminal, the manager of said installation, so that the latter can decide what actions to take according to the data received from the slave terminals.

An example of such installations includes air conditioning systems for motor vehicles in which remote computers or user interfaces in various areas of the vehicle, such as the front and rear doors, receive set values from the users for certain parameters, in particular the desired temperature or air flow. These set values are routed via the communication bus to a central computer that then appropriately manages the various parts of the air conditioning system, such as the air circulation valves, so as to best match the set values received.

The prior art, in particular in the field of motor vehicle air conditioning, describes data transmission methods that involve, for the master terminal, which is the central computer in the chosen example, of sequentially querying the slave terminals, namely the remote computers or user interfaces, so as to obtain, from them, the data needed for the overall management of the system for which it is responsible. The master terminal therefore opens a series of response frames in which the slave terminals take turns transmitting the data that they have in order to inform the master terminal.

However, these known data transmission methods have the disadvantage of operating in sequential mode in the sense that all of the slave terminals are systematically queried in their turn according to a cyclical procedure, even if the data that they must transmit to the master terminal has not changed from one cycle to the next. Moreover, the slave terminals are required to respond to the query from the master terminal by transmitting the current data to it even when this data has already been provided in the previous cycle. Finally, the length of the allocated data sequence is identical for all of the slave terminals, without taking into account the specificities of each slave terminal. The access time and response time are therefore abnormally lengthened, and the user therefore does not immediately obtain the desired effect. In addition, the energy consumption is increased by the sequential operation of the communication bus of the prior art.

It can be understood that these known methods result in unnecessary redundancy in the data transmission as well as management that is far from being optimized in the data transmission sequence allocated to each slave terminal.

In addition, the technical problem to be solved by the subject matter of this invention is that of providing a method for transmitting data from a plurality of slave terminals to a master terminal via a communication bus, that would in particular enable the communication flow on the bus to be reduced and adjusted strictly to the requirement of the slave terminals.

The solution to the stated technical problem, according to this invention, consists of said method including the following steps:

(a) the master terminal transmits a check sequence including a response sequence, intended to receive, from the slave terminals, an indicator of the presence of data to be transmitted,

(b) the slave terminals provide said presence indicator in said response sequence,

(c) the master terminal provides a data transmission authorization to a slave terminal of which the indicator of the presence of data to be transmitted is positive,

(d) said slave terminal transmits said data after receiving the authorization from the master terminal,

(e) steps (c) and (d) are repeated for any slave terminal of which the indicator of the presence of data to be transmitted is positive.

Thus, it is understood that only the slave terminals with new data to be transmitted to the master terminal will provide a positive presence indicator, which enables the master terminal to identify, at the end of the response sequence, the slave terminals to which it will give, in turns, the authorization to transmit data.

It results from the method according to the invention that no unnecessary data is transmitted over the communication bus. In particular, no slave terminal must transmit data already sent in a previous query cycle. The flow over the communication bus is therefore reduced to the strict minimum required.

In addition, according to the invention, the slave terminals are identified by the position of their indicator of the presence of data to be transmitted in said response sequence. In this way, the master terminal, which has identified the slave terminals that have data to transmit to it, can determine the length of the data sequence to be allocated to each of them, for example, by means of a predetermined correspondence table. The length of the data sequences is therefore not set once and for all for all of the slave terminals, but is adjusted according to the slave terminal in question.

It should be noted that instead of using a table to determine the length of the data sequence of each slave terminal, the invention also stipulates that said indicator of the presence of data to be transmitted include an indicator of the length of the data to be transmitted.

According to an embodiment of the invention, said communication bus is a single-wire bus with a dominant state and a recessive state. In this case, the invention stipulates that said indicator of the presence of data to be transmitted is obtained by forcing the dominant state of the bus.

Finally, according to another embodiment of the invention, said communication bus is a two-wire bus.

The following description of the appended drawings, given by way of non-limiting examples, will make it easier to understand the invention and how it can be carried out.

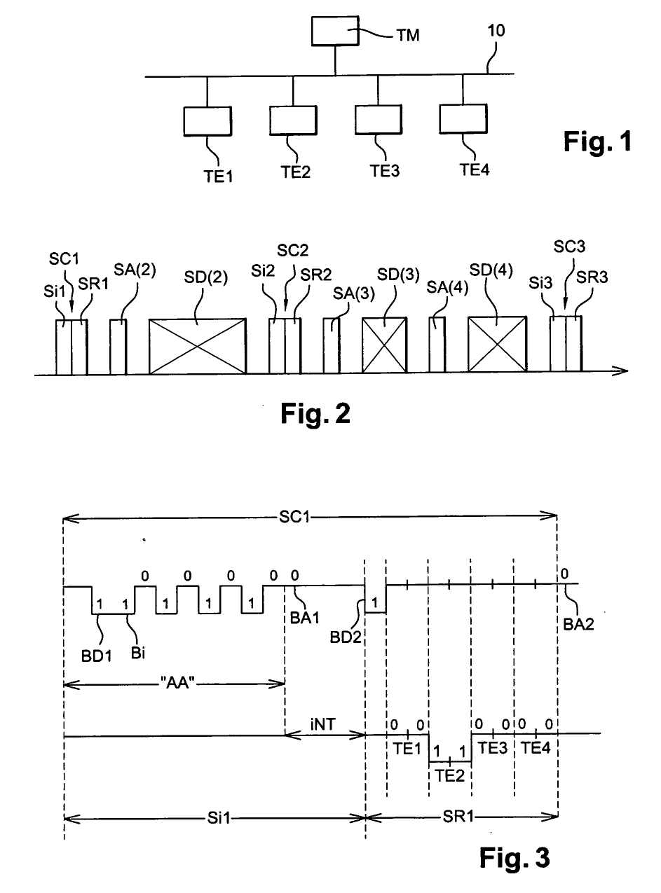

FIG. 1 is a connection diagram between a master terminal and a plurality of slave terminals on a single-wire bus.

FIG. 2 is an example of sequences circulating over the communication bus during the implementation of the method according to the invention.

FIG. 3 is a diagram showing the constitution of a check sequence shown in FIG. 2.

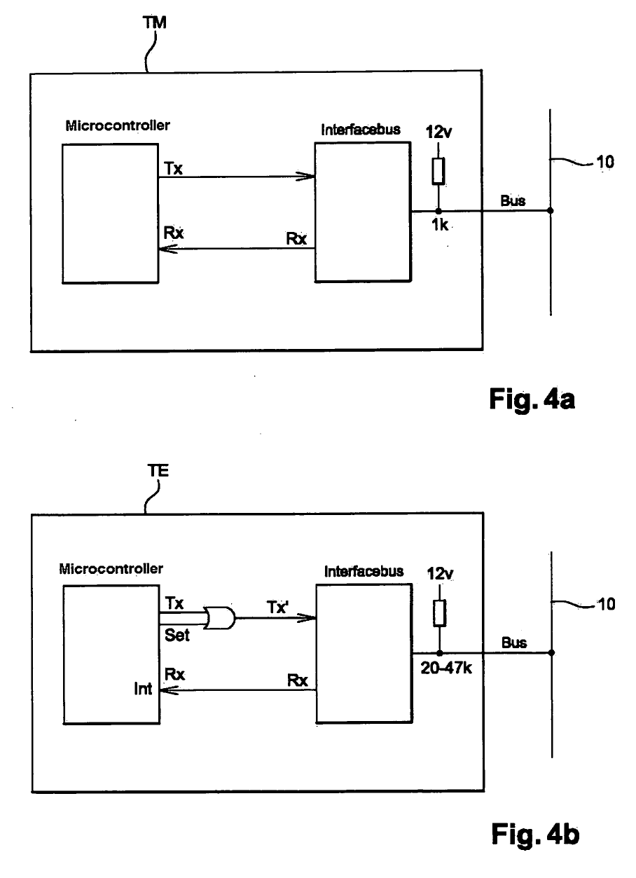

FIG. 4a is a diagram of a master terminal connected to the communication bus.

FIG. 4b is a diagram of a slave terminal connected to the communication bus.

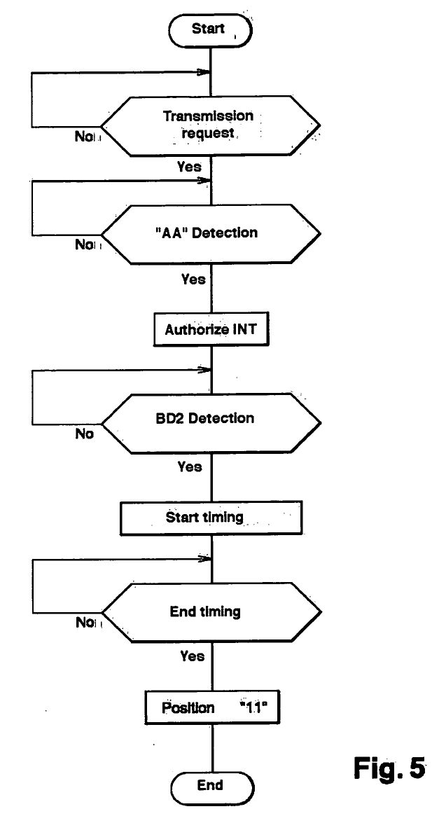

FIG. 5 is a diagram showing the various steps of the data communication method according to the invention.

FIG. 1 shows a single-wire communication bus 10 connecting a master terminal TM to, for example, four slave terminals TE1, TE2, TE3, TE4, with the object of the invention being a method enabling said slave terminals to transmit data to the master terminal in particular in the context of a motor vehicle air conditioning system.

The bus 10 is advantageously a single-wire bus with a dominant state and a recessive state, in accordance with ISO standard 9141. However, the invention is not limited to this type of bus and can also be implemented using a two-wire bus.

As shown in FIG. 2, the communication exchanges between the master terminal TM and the slave terminals TE1, TE2, TE3, TE4 are organized around a series of check sequences SCi with i=1, 2, 3 in the example chosen, wherein the index i is simply a number in chronological order of the various sequences. These check sequences are initiated by the master terminal TM and are intended to let it know which slave terminals have new data to transmit to it.

It can be noted that, alternatively, the response sequence can be initialized by any one of the slave terminals.

To this end, each check sequence SCi includes an initialization sequence SIi followed by a response sequence Sri. The initialization sequence is solely intended to notify the slave terminals of the arrival of a response sequence in which they can provide, as the case may be, an indicator of the presence of data to be transmitted.

By way of example, FIG. 3 shows the structure of the sequence SC1 of FIG. 2.

To identify a sequence SC1 as the initialization sequence, it can be identified in the fame by at least one characteristic bit, for example and initial bit B1 equal to 1 at the beginning of the sequence, located immediately after the start bit BD1 which, according to the UART (“Universal Asynchronous Receiver Transmitter”) protocol, systematically precedes the eight-bit sequence to be transmitted. The word constituting the initialization sequence is designated by “AA”.

After a stop bit BA1 marking the end of the initialization sequence SI1 and the interruption INT between two consecutive eight-bit sequences in the frame, the response sequence SR1 begins with a start bit BD2 providing the slave terminals with a response zone specific to them so that they can indicate whether they have data to be transmitted. The response zone allocated to each slave terminal is identified by its position in the sequence, which position is defined by a timing counted from the start bit BD2.

In the example of FIG. 3, the slave terminal TE1 has a two-bit response zone that immediately follows the start bit BD2, then the slave terminal TE2 in turn has a two-bit response zone, and so on.

The steps of the check sequence are shown in the diagram of FIG. 5.

Also in the specific example of FIG. 3, only the slave terminal TE2 has placed, in the response zone assigned to it, an indicator of the presence of data to be transmitted in the form of a two-bit word equal to 1: “11”. Of course, while the response zone of each slave terminal may have any number of bits, the choice of two bits is justified in this case due to questions of redundancy, in consideration of possible bit losses over the communication bus.

The bits 1 of the presence indicator “11” can be obtained by forcing the dominant state of the single-wire bus 10 with a dominant state and a recessive state. The device enabling a slave terminal to force this is shown in FIG. 4b. The interface between the microcontroller of the terminal TE and the bus 10 consists of an “OR” logic gate of which the output port Tx′ is forced to 1 regardless of the logic state of the port Tx by applying a logic state 1 to the “Set” terminal. The “OR” gate will not be necessary of the port Tx already has a forcing characteristic.

FIG. 4a shows the diagram of a master terminal associated with the slave terminal of FIG. 4b.

At the end of the check sequence SC1, the master terminal is therefore capable of determining which slave terminals have data to transmit to it, i.e. terminal TE2 in the example chosen.

As can be seen in FIG. 2, the master terminal TM then transmits an authorization sequence SA(2) indicating to the slave terminal TE2 that it can transmit data that must be sent. The index “2” in parentheses in the symbol SA(2) refers to the number identifying the slave terminal in question, in this case TE2.

Finally, in response to the authorization sequence SA(2), the terminal TE2 transmits its data in a data sequence SD(2).

After having received the data sequence SD(2), the master terminal transmits a new check sequence SC2 including an initialization sequence SI2, identical to SI1, and a response sequence SR2 to which, for example, both slave terminals TE3 and TE4 will have responded positively. In this case, the master terminal sends a first authorization sequence SA(3) followed by a data sequence SD(3) sent by terminal TE3, then a second authorization sequence SA(4) followed by a data sequence SD(4) sent by terminal TE4.

At the end of the last data sequence SD(4), the master terminal TM again sends a check sequence SC3. In the example of FIG. 2, no slave terminal has responded positively to this sequence.

The master terminal then cyclically retransmits a new check sequence.

It is understood that the method according to the invention functions asynchronously, which is possible due to the fact that the master terminal knows in advance the length of the data sequence associated with each slave terminal. The advantage of this type of operation is that it limits circulation over the bus to the strict minimum required and therefore reduces the flow, unlike the known methods operating in sequential mode.

The master terminal can determine the length of data sequences of the slave terminals by means of a predetermined table providing the correspondence between the length and the slave terminal. It is also possible for this information to be given in a length indicator associated with the presence indicator, with both indicators being provided in the response zone allocated to each slave terminal in the response sequence. For example, the response zone can be extended to three bits of which one indicates that the data will be transmitted in a long word (bit to 1) or a short word (bit to 0).

As the indicators of the presence of data to be transmitted are provided in the frame by the slave terminals independently of one another, it is recommended, so as to avoid any overlap, that the precision of the clocks of said terminals be as high as possible, for example, better than 2%.

1. Method for transmitting data from a plurality of slave terminals (TE1, TE2, TE3, TE4) to a master terminal (TM) via a communication bus (10), characterized in that said method includes the following steps:
(a) the master terminal (TM) transmits a check sequence (SCi) including a response sequence (SRi), intended to receive, from the slave terminals (TE1, TE2, TE3, TE4), an indicator of the presence of data to be transmitted,
(b) the slave terminals provide said presence indicator in said response sequence (SRi), (c) the master terminal (TM) provides a data transmission authorization (SA) to a slave terminal of which the indicator of the presence of data to be transmitted is positive,
(d) said slave terminal transmits said data after receiving the authorization from the master terminal, (e) steps (c) and (d) are repeated for any slave terminal of which the indicator of the presence of data to be transmitted is positive.

2. Method according to claim 1, characterized in that the slave terminals (TE1, TE2, TE3, TE4) are identified by the position of their indicator of the presence of data to be transmitted in said response sequence (SRi).

3. Method according to one of claims 1 or 2, characterized in that said control sequence (SCi) includes an initialization sequence (SIi) preceding said response sequence (SRi).

4. Method according to claim 3, characterized in that said initialization sequence (SIi) is identified by at least one characteristic bit.

5. Method according to any one of claims 1 to 4, characterized in that said indicator of the presence of data to be transmitted includes an indicator of the length of the data to be transmitted.

6. Method according to any one of claims 1 to 5, characterized in that said response sequence (SRi) is initialized by a slave terminal.

7. Method according to any one of claims 1 to 6, characterized in that said communication bus (10) is a single-wire bus with a dominant state and a recessive state.

8. Method according to claim 7, characterized in that said indicator of the presence of data to be transmitted is obtained by forcing the dominant state of the bus (10).

9. Method according to any one of claims 1 to 8, characterized in that said communication bus (10) is a two-wire bus.

10. Communication bus between a master terminal (TM) and at least one slave terminal (TE1, TE2, TE3, TE4) characterized in that the master terminal (TM) transmits a control sequence (SCi) including a response sequence (SRi) intended to receive, from the slave terminals (TE1, TE2, TE3, TE4), an indicator of the presence of data to be transmitted, in that the slave terminals provide said presence indicator in said response sequence (SRi), in that the master terminal (TM) provides a data transmission authorization (SA) to a slave terminal of which the indicator of the presence of data to be transmitted is positive, and in that said slave terminal of which the indicator of the presence of data to be transmitted is positive transmits said data after receiving the authorization from the master terminal (TM).
